(19) United States
(12) Patent Application Publication
(10) Pub. No.: US 2010/0199343 A1
(43) Pub. Date: Aug. 5, 2010

(54) CLASSIFICATION OF WIRED TRAFFIC BASED ON VLAN

(75) Inventor: Ravinder Verma, Varthur Hobli (IN)

Correspondence Address: BLAKELY SOKOLOFF TAYLOR & ZAFMAN LLP, 1279 OAKMEAD PARKWAY, SUNNYVALE, CA, 94085-4040, US

(73) Assignee: ARUBA NETWORKS, INC., Sunnyvale, CA (US)

(21) Appl. No.: 12/365,025

(22) Filed: Feb. 3, 2009

(51) Int. Cl. H04L 9/32

(52) U.S. Cl. 726/11

(57) ABSTRACT

Controlling access and capabilities on wired digital networks. According to the invention, rather than use port-centric controls, multiple virtual local area networks (VLANs) are supported by a wired controller, and these VLANS may be terminated on multiple physical ports. Capabilities are then assigned on a VLAN basis, with default capabilities assigned to the port when no VLAN is used. By defining capabilities on a VLAN basis, as an example no access, trusted access, or untrusted access. Trusted access VLANS are not subject to authentication or firewalling. Untrusted VLANS are subject to authentication and firewalling, which may be configured as required for the VLAN and its authorized users.

### BACKGROUND OF THE INVENTION

The present invention relates to digital networks, and in particular, to the problem of handling and securing traffic on wired digital networks.

Wired digital networks, such as those operating to IEEE802.3 Ethernet standards, provide a wide range of services, which may include access to local digital services such as printers, file shares, other computer users, and to the larger, global Internet.

In many cases, individuals and/or organizations operating wired digital networks may wish to control the traffic flowing through the digital networks in their purview.

Typical methods of exercising such control are port-centric: they are based on the configuration of the equipment, and associate a set of capabilities with a particular physical port. As an example, unused ports may be disabled, not allowing any traffic to pass. Ports may be marked as trusted, in which case all traffic through them is passed without filtering or authentication, as with a normal switch. Ports may also be marked as untrusted, in which case all traffic through that port is authenticated and firewalled.

Such port-centric models are popular, but introduce complications. When both trusted and untrusted traffic must be passed through a larger network, multiple ports, trusted and untrusted, must be tied up. Accurate records should be kept of each port and its capabilities. When a port fails, or networks are changed, the configuration of affected ports must be changed as well.

What is needed is a method of exercising such control that is not port-centric.

### BRIEF DESCRIPTION OF THE DRAWINGS

The invention may be best understood by referring to the following description and accompanying drawings that are used to illustrate embodiments of the invention in which:

FIG. 1 shows a wired digital network.

### DETAILED DESCRIPTION

Embodiments of the invention relate to methods of controlling access and capabilities on wired digital networks. According to the present invention, rather than use port-centric controls, multiple virtual local area networks (VLANs, such as those defined in the IEEE 802.1Q standard) are supported by a wired controller, and these VLANS may be terminated on multiple physical ports. Capabilities are then assigned on a VLAN basis, with default capabilities assigned to the port when no VLAN is used. VLANS may be identified as trusted or untrusted. Traffic on a trusted VLAN is passed without authentication or firewalling. Traffic on an untrusted VLAN must be authenticated, and once authenticated, that traffic is passed through a firewall according to the configuration rules for that VLAN.

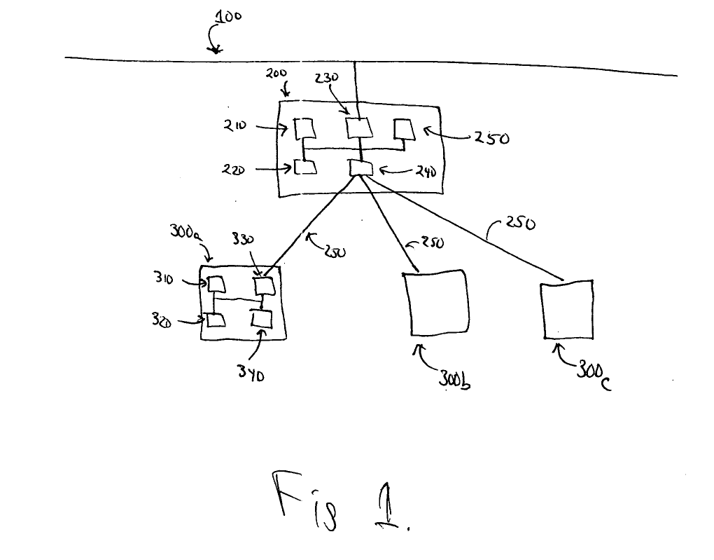

As shown in FIG. 1, a wired network operating according to 803.2 Ethernet standards supports connections of wired clients 300 to a wired network. Wired network 100, such as a wired IEEE 802.3 Ethernet network, is connected to controller 200. Controller 200 supports connections 250 to wired clients 300a, 300b, 300c.

As is understood in the art, controller 200 is a purpose-built digital device having a CPU 210, memory hierarchy 220, and a plurality of network interfaces 230, 240. CPU 210 may be a MIPS-class processor from companies such as Raza Microelectronics or Cavium Networks, although CPUs from companies such as Intel, AMD, IBM, Freescale, or the like may also be used. Memory hierarchy 220 includes read-only memory for device startup and initialization, high-speed read-write memory such as DRAM for containing programs and data during operation, and bulk memory such as hard disk or compact flash for permanent file storage of programs and data. Network interfaces 230, 240 are typically IEEE 802.3 Ethernet interfaces to copper, although high-speed optical fiber interfaces may also be used. Controller 200 typically operates under the control of purpose-built embedded software, typically running under a Linux operating system, or an operating system for embedded devices such as VXWorks.

Similarly, as understood by the art, wired clients 300a, 300b and 300c are also purpose-built digital devices. These clients 300 are also digital devices, similarly having CPU 310, memory hierarchy 320, wired interface 330, and I/O devices 340. As examples, clients 300 may include printers, file servers, scanners, general purpose computers, and the like. In a general-purpose computer, CPU 310 may be a processor from companies such as Intel, AMD, Freescale, or the like. In the case of purpose-built devices, Acorn or MIPS class processors may be preferred. Memory hierarchy 320 comprises the similar set of read-only memory for device startup and initialization, fast read-write memory for device operation and holding programs and data during execution, and permanent bulk file storage using devices such as flash, compact flash, and/or hard disks. Additional I/O devices 340 may be present, such as keyboards, displays, speakers, barcode scanners, and the like.

According to an aspect of the invention, controller 200 provides multiple VLANs accessible on wired ports. These VLANS may be identified and implemented in accordance with the IEEE 802.1Q standard, which defines VLAN tags (IEEE 802.1Q-2005, incorporated herein by reference). Capabilities not part of the 802.1Q standard are associated with each VLAN, and a default capability is associated with the wired ports when no VLAN is used. VLANS may be trusted or untrusted. VLAN identities, capabilities, and authentication memberships may be stored in a database 250 accessible by controller 200.

In the case where no VLAN is specified on wired traffic, that traffic may be defaulted to be trusted or untrusted. In the case where traffic is trusted, all traffic is passed without authentication or firewalling. In the case where traffic is untrusted, authentication and/or firewalling may be used. As an example, untrusted access may be provided on a network when no virtual local area network is specified, firewalled to only support those ports and protocols necessary for connecting and operating network printers. This is useful for example for devices such as network printers and scanners that do not need or support authentication.

Similarly, a VLAN may be marked as trusted, in which case all traffic on that VLAN is passed without authentication or firewalling.

When a VLAN is marked untrusted, all traffic on that VLAN is subject to authentication and/or firewalling. Authentication may range from simple MAC address verification to more complex and secure methods. Once authenticated, traffic is passed through a firewall according to firewall rules established for that VLAN configuration. As an example, a particular VLAN may allow only traffic on certain ports and/or protocols, for example, only allowing traffic on a certain group of ports and blocking traffic on all others.

Firewalls are known to the art, and are represented for example by open source products such as ipf under Unix, ipfw for BSD/MacOS, and iptables/ipchains for Linux.

Authentication may be configured separately from firewalling. As examples, a VLAN may be set up to require authentication but not require firewalling of traffic. Similarly, a VLAN may be set up which does not require authentication, but firewalls traffic, only permitting certain ports and protocols to be used.

While the invention has been described in terms of various embodiments, the invention should not be limited to only those embodiments described, but can be practiced with modification and alteration within the spirit and scope of the appended claims. The description is this to be regarded as illustrative rather than limiting.

What is claimed is:

1. A method of controlling port traffic on a wired local area network controller having a plurality of ports comprising;
providing one or more virtual local area networks associated with one or more of the ports,
associating capabilities with the one or more virtual local area networks, and
authenticating and/or firewalling traffic on the virtual local area networks associated with the ports based on the capabilities associated with the virtual local area network.

2. The method of claim 1 further comprising associating a default capability with port traffic not associated with a virtual local area network.

3. The method of claim 1 where the capability associated with a virtual local area network is trusted access whereby port traffic on a trusted access virtual local area network is neither authenticated nor firewalled.

4. The method of claim 1 where the capability associated with a virtual local area network is untrusted access whereby port traffic on an untrusted access virtual local area network is authenticated and/or firewalled.

5. The method of claim 2 where the default capability associated with port traffic not associated with a virtual local area network is no access whereby port traffic not associated with a virtual local area network is blocked.

6. The method of claim 2 where the default capability with port traffic not associated with a virtual local area network is trusted access whereby port traffic not associated with a virtual local area network is neither authenticated nor firewalled.

7. The method of claim 2 where the default capability with port traffic not associated with a virtual local area network is untrusted access whereby port traffic not associated with a virtual local area network is authenticated and/or firewalled.
